(19) United States
(12) Patent Application Publication
(10) Pub. No.: US 2025/0066645 A1
(43) Pub. Date: Feb. 27, 2025

(54) Compositions Including Copolymers of Isobutylene and Paramethylstyrene Substantially Free of Paramethylstyrene Monomers and Methods of Making the Same

(71) Applicant: ExxonMobil Technology and Engineering Company, Baytown, TX (US)

(72) Inventors: Sunny Jacob, Seabrook, TX (US); John A. CLARK, Seabrook, TX (US); Tu N. PHAM, Houston, TX (US)

(21) Appl. No.: 18/717,510

(22) PCT Filed: Dec. 13, 2022
(86) PCT No.: PCT/US2022/052674

§ 371 Date: Jun. 7, 2024

Related U.S. Application Data
(60) Provisional application No. 63/290,698, filed on Dec. 17, 2021.

(51) Int. Cl. C09J 125/16; C09J 125/18

(52) U.S. Cl. CPC C09J 125/16; C09J 125/18

(57) ABSTRACT

A process for preparing a cement composition comprising an isoolefin-alkylstyrene copolymer and substantially free of an alkylstyrene monomer is described herein. The process comprises reacting the isoolefin monomer with at least a portion of the alkylstyrene monomer in a diluent to form an isoolefin-alkylstyrene copolymer, replacing the diluent with a solvent, reacting a halogenic scavenger with the unreacted alkylstyrene monomer in an absence of a free radical initiator in order to form a halogenic alkylstyrene compound without altering the isoolefin-alkylstyrene copolymer, and removing the halogenic alkylstyrene compound from the slurry to form the cement composition substantially free of the alkylstyrene monomer. Also disclosed herein is a composition comprising an isoolefin-alkylstyrene copolymer and an alkylstyrene monomer comprising a concentration less than about 20 ppm.

### CROSS REFERENCE TO RELATED APPLICATIONS

This application claims priority to and the benefit of U.S. Provisional Application No. 63/290,698, filed Dec. 17, 2021, the disclosure of which is incorporated herein by reference in its entirety.

### FIELD

The present disclosure relates to compositions including copolymers of isobutylene and paramethylstyrene.

### BACKGROUND

This section is intended to provide relevant background information to facilitate a better understanding of the various aspects of the described embodiments. Accordingly, it should be understood that these statements are to be read in this light and not as admissions of prior art.

Isobutylene-paramethylstyrene (“IPMS”) copolymers are used throughout the tire and pharmaceutical industries. The copolymers are industrially produced by a cationic slurry polymerization process using a catalyst system comprising a Lewis Acid and an initiator.

Brominated isobutylene-paramethylstyrene (“BIMS”) copolymers can be produced via slurry polymerization and bromination in a continuous, single-step, solvent replacement process. Isobutylene and paramethylstyrene (“pMS”) monomers are first suspended in a diluent such as methyl chloride with a catalyst system and copolymerized. During bromination of the produced copolymer, a solvent such as hexane is washed over the slurry to replace the diluent. Residual unreacted pMS monomers in the slurry are brominated along with the BIMS copolymers. The brominated pMS monomers are subsequently hydrolyzed and volatilized for removal. Continuous copolymer production maintains a steady low level of pMS monomers in the slurry, leading to consistently low concentrations of stearic acid in the finished copolymer.

A bromobutyl rubber plant may produce both brominated and non-brominated copolymers. In the production of non-brominated IPMS copolymers, the unreacted pMS monomers are likewise not brominated. These free, non-brominated pMS monomers are partially stripped from the slurry during solvent replacement and accumulate in the bulk hexane. The remaining free pMS will stay in the copolymer slurry at an unacceptably high level, and in certain applications it is not desirable to have such high levels of free pMS. If the plant switches to production of BIMS copolymers or bromobutyl rubber, the excess pMS monomers in the hexane will be brominated, but may not be fully hydrolyzed and removed due to their excessive concentration. This accumulation of pMS monomers leads to unacceptably high stearic acid in the finished brominated copolymer. Therefore, a need exists for a process of alternatively producing brominated and non-brominated isobutylene-paramethylstyrene copolymers without excessive accumulation of free pMS monomers in the hexane recycle stream and in the finished IPMS rubber.

Embodiments provided herein generally relate to a process for production of cement compositions comprising an isoolefin-alkylstyrene copolymer and substantially free of an alkylstyrene monomer. More particularly, embodiments provided herein relate to a process for production of cement compositions comprising an isobutylene-paramethylstyrene copolymer and substantially free of a paramethylstyrene monomer.

### SUMMARY

Disclosed in one or more embodiments is a process for preparing a cement composition comprising an isoolefin-alkylstyrene copolymer and substantially free of an alkylstyrene monomer. The process comprises reacting the isoolefin monomer with at least a portion of the alkylstyrene monomer in a diluent to form an isoolefin-alkylstyrene copolymer; replacing the diluent with a solvent; reacting a halogenic scavenger with the unreacted alkylstyrene monomer in an absence of a free radical initiator in order to form a halogenic alkylstyrene compound without altering the isoolefin-alkylstyrene copolymer; and removing the halogenic alkylstyrene compound from the slurry to form the cement composition substantially free of the alkylstyrene monomer.

Disclosed in another embodiment is a composition comprising an isoolefin-alkylstyrene copolymer and an alkylstyrene monomer comprising a concentration less than about 20 ppm.

These and other features and attributes of the disclosed processes and compositions of the present disclosure and their advantageous applications and/or uses will be apparent from the detailed description which follows.

### BRIEF DESCRIPTION OF THE DRAWINGS

Embodiments of the compositions including copolymers of isobutylene and paramethylstyrene substantially free of paramethylstyrene monomers and methods of making the same are described with reference to the following figures. The same or sequentially similar numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

FIG. 1 is a table of paramethylstyrene levels in several isobutylene-paramethylstyrene copolymer cement compositions.

FIG. 2 is a table of paramethylstyrene levels in cement compositions before and after treating with bromine.

### DETAILED DESCRIPTION

Bromobutyl rubber plants alternatively produce both halogenated and non-halogenated isoolefin-alkylstyrene copolymers. When a rubber plant produces non-halogenated copolymers, the residual alkylstyrene monomers are not halogenated and accumulate in the bulk solvent and in the copolymer composition at levels unacceptably high for many applications. When switching to production of halogenated copolymers, the excess residual alkylstyrene monomers in the bulk solvent are introduced to the copolymer slurry. The free alkylstyrene monomers cannot be fully removed due to their excessive concentration. During finishing, the excess free alkylstyrene monomers may cause excessive stearic acid concentration in a dry rubber composition and a finished rubber product, leading to polymer drying and industrial hygiene concerns.

It has been discovered that a halogenic scavenger can scavenge unreacted alkylstyrene monomers from a solution comprising isoolefin-alkylstyrene copolymers. Furthermore, the halogenic scavenger can scavenge the unreacted alkylstyrene monomers without halogenating the isoolefin-alkylstyrene copolymers. When halogenating isoolefin-alkylstyrene copolymers, free radical initiators are used to speed up the halogenation reaction. In the absence of free radical initiators and light, the reaction proceeds at a negligible rate. In order to react and scavenge the unreacted alkylstyrene monomers without halogenating the isoolefin-alkylstyrene copolymers, the scavenging is performed in the absence of free radical initiators. Free radical initiators such as Vazo™ 52, Vazo™ 64, Vazo™ 67, Vazo™ 88 are not added to the reaction mixture, and the reaction is carried out in darkness.

The scavenging described herein allows the conversion of unreacted alkylstyrene monomers into a more easily removable halogenic alkylstyrene compound. The halogenic alkylstyrene compound is subsequently hydrolyzed and removed by volatilization during drying. Without scavenging, the unreacted alkylstyrene monomers can build up excessively in solution, leading to excessive stearic acid concentrations in finished halogenated copolymers. Excessively high alkylstyrene monomer concentration in the copolymer composition is not desirable for many applications, such as those applications involving production of bromobutyl rubber with pMS monomers. Scavenging unreacted alkylstyrene monomers during production of non-halogenated isoolefin-alkylstyrene copolymers allows production of halogenated isoolefin-alkylstyrene copolymers without excessive buildup of unreacted alkylstyrene monomers. Elimination of excessive buildup of unreacted alkylstyrene monomers would allow, for example, a plant to switch from production of non-halogenated isoolefin-alkylstyrene copolymers to production of halogenated isoolefin-alkylstyrene copolymers without needing to replace the bulk solvent.

Various specific embodiments will now be described, including definitions that are adopted herein. While the following detailed description gives specific embodiments, those skilled in the art will appreciate that these embodiments are exemplary only, and that components of each embodiment may be used in other embodiments as appropriate and that the present embodiment can be practiced in other ways. Any reference to the “invention” may refer to one or more, but not necessarily all, of the present inventions defined by the claims. The use of headings is for purposes of convenience only and does not limit the scope of the present invention.

### Definitions

As used herein, the term “catalyst system” refers to and includes any Lewis Acid or other metal complex used to catalyze the polymerization of the olefinic monomers, as well as the initiator described below, and other minor catalyst components.

“Slurry” refers to a volume of diluent comprising monomers, Lewis acid, initiator, and polymers that have precipitated from the diluent, The “slurry concentration” is the weight percent of these reacted monomers—the weight percent of the reacted monomers by total weight of the slurry, diluent, unreacted monomers, and catalyst system.

“Polymer” may be used to refer to homopolymers, copolymers, interpolymers, terpolymers, etc. Likewise, a copolymer may refer to a polymer comprising at least two monomers, optionally with other monomers.

When a polymer is referred to as comprising a monomer, the monomer is present in the polymer in the polymerized form of the monomer or in the derivative form the monomer. However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

“Isobutylene-based elastomer” or polymer refers to elastomers or polymers comprising at least 70 mol % repeat units from isobutylene.

“Hydrocarbon” refers to molecules or segments of molecules containing primarily hydrogen and carbon atoms. In some embodiments, hydrocarbon also includes halogenated versions of hydrocarbons and versions containing heteroatoms.

“Alkyl” refers to a paraffinic hydrocarbon group which may be derived from an alkane by dropping one or more hydrogens from the formula, such as, for example, a methyl group (CH₃), or an ethyl group (CH₃CH₂), etc.

“Rubber” refers to any polymer or composition of polymers consistent with the ASTM D1566 definition: “a material that is capable of recovering from large deformations, and can be, or already is, modified to a state in which it is essentially insoluble (but can swell) in boiling solvent . . . ”. Elastomer is a term that may be used interchangeably with the term rubber.

“Diluent” means a diluting or dissolving agent. Diluent is specifically defined to include chemicals that can act as dissolving agents, i.e., solvents, for the Lewis Acid, other metal complexes, initiators, monomers, or other additives, but which preferably do not act as dissolving agents for the elastomer obtained through polymerization of the dissolved monomers. In the practice, the diluent does not alter the general nature of the components of the polymerization medium, i.e., the components of the catalyst system, monomers, etc. However, it is recognized that interactions between the diluent and reactants may occur. In preferred embodiments, the diluent does not react with the catalyst system components, monomers, etc., to any appreciable extent. Additionally, the term diluent includes mixtures of at least two or more diluents. Diluents are generally hydrocarbon liquids which may be halogenated with chlorine or fluorine.

“Solvent” means a hydrocarbon liquid that is capable of acting as a dissolving agent for an elastomeric polymer.

“Isoolefin” refers to a C₄ to C₇ compound and includes, but is not limited to, isobutylene, isobutene, 2-methyl-1-butene, 3-methyl-1-butene, 2-methyl-2-butene, and 4-methyl-1-pentene.

“Unreacted/Free/Residual monomers” refer to monomeric units which have not been polymerized with any other monomeric units. Unreacted/Free/Residual monomers can refer to unpolymerized monomers present in a slurry or solution before, during, or after a polymerization reaction.

### Copolymerization

Isoolefin-alkylstyrene copolymers are produced via slurry polymerization, optional halogenation, and finishing. Whether producing halogenated or non-halogenated copolymers, the slurry polymerization is performed in a continuous solvent replacement process. First, isoolefin monomers and alkylstyrene monomers are suspended in a slurry in preparation to be copolymerized. The isoolefin monomer is selected from the group consisting of isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. In one or more embodiments, the isoolefin monomer is an isobutylene monomer. The alkylstyrene monomer is derived from a C₁ to C₇ alkyl. In one or more embodiments, the alkylstyrene monomer is a paramethylstyrene monomer.

The monomers are suspended in a diluent which can be polar or nonpolar. Suitable nonpolar diluents include hydrocarbons and aromatic and cyclic hydrocarbons such as methylcyclohexane, cyclohexane, toluene, carbon disulfide, and combinations thereof. Suitable polar diluents include chlorinated and fluorinated hydrocarbons, normal, branched chain or cyclic hydrocarbons, ethyl chloride, methylene chloride, methyl chloride, CHCl₃, CCl₄, n-butyl chloride, chlorobenzene, and other chlorinated hydrocarbons. In one or more embodiments, the diluent is methyl chloride.

The slurry also includes a catalyst system to catalyze the copolymerization reaction. The catalyst system includes a Lewis Acid, an initiator, and optionally oxygenates and ion containing species. The Lewis acid is a Group 13 Lewis acid having the formula RₙMX₃₋ₙ, wherein M is a Group 13 metal, R is a monovalent hydrocarbon radical selected from the group consisting of C₁ to C₁₂ alkyl, aryl, arylalkyl, alkylaryl and cycloalkyl radicals; and n is an integer from 0 to 3; and X is a halogen independently selected from the group consisting of fluorine, chlorine, bromine, and iodine. Alternatively, the Lewis acid can be selected from the group consisting of ethyl aluminum sesquichloride (EASC), aluminum bromide, boron trichloride, diethylaluminum chloride, dimethylaluminum chloride, aluminum trichloride, alkyl aluminum dichloride, boron trifluoride, tin tetrachloride, titanium tetrachloride, diisobutylaluminum chloride, and mixtures thereof. Weaker Lewis acids lead to less alkylation and branching and higher monomer conversion rates. The initiator includes water, hydrochloric acid, organic acids, alkyl halides, and combinations thereof. The initiator, in a suitable diluent and in combination with the Lewis Acid, forms a polymer chain which propagates to form the copolymer. Oxygenates and ion-containing species such as triphenylmethyl chloride may be added to the slurry where a stronger Lewis Acid is used.

Reactor conditions such as temperature, pressure, and reactant concentrations are monitored and maintained in order to keep the reactor contents in a slurry medium and to copolymerize the isoolefin and alkylstyrene monomers. In one or more embodiments, a feed stream comprises a total concentration of isoolefin monomers and alkylstyrene monomers greater than about 30 wt %, or greater than about 35 wt %, or between about 35 and about 50 wt %, based on the total weight of monomers, diluent, and catalyst system. In one or more embodiments, the polymerization reaction temperature is between about −10° C. and about −120° C., between about −40° C. and about −110° C., or between about −80° C. and about −100° C. In one or more embodiments, the polymerization reaction pressure is between about 200 (29.00 psi) and about 1600 kPa (232.06 psi), between about 300 (43.51 psi) and about 1200 kPa (174.05 psi), or between about 400 (58.02 psi) and about 1000 kPa (145.04 psi).

After copolymerization, stabilizers such as calcium stearate and an antioxidant such as butylated hydroxytoluene (“BHT”) can be introduced to the slurry to stabilize the copolymer and prevent agglomeration. The diluent is also replaced with a solvent suitable for halogenation and finishing. Where the diluent is methyl chloride, the methyl chloride vaporizes as the solvent is poured into the slurry. The solvent is an inert hydrocarbon such as a C₄ to C₁₀ aliphatic, cycloaliphatic or aromatic liquid. In one or more embodiments, the solvent comprises hexane, isohexane, cyclohexane, cyclohexene, pentane, isopentane, heptane, benzene, or combinations thereof. In one or more embodiments, the solvent is hexane. In one or more embodiments, the solvent is a halogen-containing solvent comprising chlorobenzene, carbon tetrachloride, chloroform, or combinations thereof.

### Halogenation

The isoolefin-alkylstyrene copolymers may then be halogenated to increase reactivity in order to facilitate vulcanization. In the production of such halogenated copolymers, once the diluent has been replaced with the solvent, the slurry is treated with a halogen to react with the isoolefin-alkylstyrene copolymer. In one or more embodiments, the halogen comprises bromine, chlorine, iodine bromide, or combinations thereof. In one or more embodiments the halogen is bromine. Where the isoolefin-alkylstyrene copolymer is an IPMS copolymer and the halogen is bromine, the halogenation reaction is preferably carried out in the presence of a free radical initiator in order to increase the rate of reaction. In one or more embodiments, the free radical initiator comprises Vazo™ 52, Vazo™ 64, Vazo™ 67, Vazo™ 88, light, or combinations thereof. Oxidizing agents such as hydrogen peroxide and sodium peroxide can also be included to increase halogen conversion. In one or more embodiments, the halogenation reaction is carried out at a reaction temperature between about 0° C. and about 150° C., between about 10° C. and about 100° C., or between about 20° C. and about 80° C. In one or more embodiments, halogenation may be carried out in a single reactor zone. In other embodiments, halogenation may be carried out in two or more reaction zones. In one or more of such embodiments, oxidizing agents may be added in any reaction zone.

Where the monomers comprise isobutylene and pMS, copolymerization occurs with pMS conversion between about 95 and about 99%, or between about 98 and about 99%. Thus, about 1-5%, or about 1-2% of the original pMS monomers remain in the slurry as unreacted pMS monomers. Conversion of alkylstyrene monomers is determined by an online analyzer that determines the amount of unreacted alkylstyrene monomer after the slurry exits the reactor, and then calculates the conversion based on an input feed rate. For pMS monomers, the produced copolymer is tested for the level of incorporation of pMS in the polymer, and then conversion is calculated from an input feed rate/feed blend ratio. In the production of halogenated isoolefin-alkylstyrene copolymers, unreacted alkylstyrene monomers are also halogenated. Where the halogen is bromine and the alkylstyrene monomer is pMS, the halogenation reaction produces di- and tri-bromo pMS compounds. The halogenated alkylstyrene compounds are hydrolyzed during finishing and removed via volatilization during extrusion drying. In a continuous copolymerization process, the halogenation, hydrolysis, and volatilization of free alkylstyrene monomers result in consistently low levels of free alkylstyrene monomers in the slurry which leads to low levels of stearic acid in the dry rubber composition and the finished rubber product.

When a rubber plant produces non-halogenated isoolefin-alkylstyrene copolymers, the free alkylstyrene monomers are not halogenated. Unreacted alkylstyrene monomers are stripped from the slurry during solvent recovery and accumulate in the bulk solvent. When the plant returns to halogenated copolymer production, the excess free alkylstyrene monomers accumulated in the solvent are introduced to the slurry along with the solvent. The free alkylstyrene monomers are halogenated, but cannot be fully hydrolyzed due to their excessive concentration. During finishing, the excess free alkylstyrene monomers may cause excessive stearic acid concentration in the dry rubber composition and the finished rubber product. Excessive stearic acid causes polymer drying concerns and excessive free alkylstyrene monomers can also cause industrial hygiene concerns. Furthermore, unreacted alkylstyrene monomers may be present in the dry rubber composition and the finished rubber product at levels that are unacceptably high for many applications.

### Scavenging of Unreacted Alkylstyrene Monomers

Excessive stearic acid and free alkylstyrene monomer concerns can be avoided by scavenging the unreacted alkylstyrene monomers from the slurry comprising the non-halogenated copolymer. To do so, a halogenic scavenger is introduced to react with the free alkylstyrene monomers to form halogenic alkylstyrene compounds. To scavenge the free alkylstyrene monomers without inadvertently halogenating the copolymer, the scavenging is performed in darkness and with no other free radical initiators present. The halogenic alkylstyrene compounds are subsequently hydrolyzed and removed during finishing. In one or more embodiments, the halogenic scavenger is bromine. Where the halogenic scavenger is bromine and the unreacted alkylstyrene monomer comprises pMS, the scavenging reaction proceeds via nucleophilic addition to form a dibromo pMS compound, shown in Formula I.

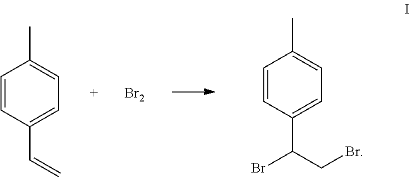

The scavenging process produces a cement composition comprising the isoolefin-alkylstyrene copolymer and being substantially free of unreacted alkylstyrene monomers. The cement composition comprises unreacted alkylstyrene monomers at a concentration less than about 30 ppm, less than about 20 ppm, or less than about 10 ppm. The scavenging of unreacted alkylstyrene monomers thus allows a rubber plant to alternatively produce both halogenated and non-halogenated copolymers without excess buildup of free alkylstyrene monomers. Suitable halogen scavengers which may be employed include bromine, alkali metal bromites, sulfur bromides, N-bromosuccinimide, alpha-bromoacetanalide, bromo hydantoins such as N,N′dibromo-5,5dimethyl hydantoin, tribromo phenol bromide, N-bromo acetanilide, beta-bromo-methyl phthalimide, and combinations thereof.

### Finishing

The cement compositions are finished to prepare a rubber product after halogenation, or after copolymerization and solvent replacement if halogenation is not performed. Halogenated copolymers are neutralized at high pH to remove acidic halogenation by-products. For both halogenated and non-halogenated copolymers, the solvent is stripped and the cement composition is dried via extrusion to a rubber crumb composition that can be baled or packaged.

Calcium stearate, BHT, and epoxidized soybean oil (“ESBO”) may be added to the cement composition to prevent dehydrohalogenation and oxidation during finishing and storage. Calcium stearate is a mild base and reacts with excess hydrogen bromide, thereby serving as a stabilizer for bromobutyl rubber. However, calcium stearate can also retard compound cure rates, so its concentration is controlled. ESBO neutralizes any free acids forming in the rubber such as stearic acid, which helps prevent excessive stearic acid concentrations in the dry rubber composition and the finished rubber product. BHT is an antioxidant that helps maintain polymer shelf life specifications and prevent degradation reactions.

The order of process steps such as halogenation, scavenging, and finishing can be rearranged while still producing isoolefin-alkylstyrene copolymers substantially free of unreacted alkylstyrene monomers. In one or more embodiments, the isoolefin-alkylstyrene copolymer is halogenated, then unreacted alkylstyrene monomers are scavenged, and then the cement composition is finished. In other embodiments, the unreacted alkylstyrene monomers are scavenged from the copolymer slurry, then the cement composition is finished, and then the dried rubber composition is re-dissolved in the solvent and halogenated to form a halogenated copolymer. In such embodiments, the scavenging step can be performed in a first reactor and the halogenation step can be performed in a second reactor. Furthermore in such embodiments, the finished rubber product can comprise stearic acid at a concentration less than about 0.1 wt %, less than about 0.5 wt %, less than about 1 wt %, or alternatively greater than about 0.1 wt %.

### Cement Composition and Copolymer Properties and Applications

The processes described above can be used to prepare cement compositions substantially free of unreacted alkylstyrene monomers. The cement compositions comprise unreacted alkylstyrene monomers at a concentration less than about 30 ppm, less than about 20 ppm, or less than about 10 ppm, as measured by gas chromatography Test Method E242. In one or more embodiments, the cement composition comprises less than about 20 ppm unreacted alkylstyrene monomers. The dry rubber composition comprises stearic acid at a concentration less than about 0.1 wt %, less than about 0.05 wt %, or about 0.0 wt %. In one or more embodiments, the finished rubber product comprises less than about 0.1 wt %. The finished rubber product comprises stearic acid at a concentration less than about 0.1 wt %, less than about 0.05 wt %, or about 0.0 wt %. In one or more embodiments, the finished rubber product comprises less than about 0.1 wt %.

In cement compositions, dry rubber compositions, and finished rubber products prepared by the processes described herein, the isoolefin-alkylstyrene copolymer has a weight average molecular weight between about 25,0000 and about 2,000,000, or between about 50,0000 and about 1,000,000, or between about 100,000 and about 500,000 g/mol. The isoolefin-alkylstyrene copolymer has a polydispersity index or molecular weight distribution between about 2.0 and about 3.0, between about 2.2 and about 2.8, between about 2.4 and about 2.6, or about 2.5. The isoolefin-alkylstyrene copolymer comprises between about 0.5 and about 20 mol %, between about 1 and about 15 mol %, or between about 5 and about 10 mol % alkylstryene monomers. The isoolefin-alkylstyrene copolymer comprises between about 80 and about 99.5 mol %, between about 85 and about 99 mol %, or between about 90 and about 95 mol % isoolefin monomers.

Molecular weight and molecular weight distribution were measured by the test method described herein. The molecular weight was measured using a Tosoh EcoSEC HLC-8320GPC instrument with enclosed Refractive Index (RI) Ultraviolet and (UV) detectors. The instrument was controlled and molecular weight was calculated using EcoSEC Workstation (Version 1.11) software. 4 columns (PLgel 5 am 500 Ä; 5 μm 500 Ä; 5 μm 10E3 Ä; 5 μm Mixed-D) were connected in series for effective separation. A sample was prepared by dissolving 24 mg (+/−1 mg) of hydrocarbon resin in 9 mL of tetrahydrofuran (THF) solution. The sulfur/THF solution (having a ratio of 1 mL sulfur solution per 100 mL THF solvent) was used as flow marker, for measurement of molecular weight. The dissolved sample was filtered using 0.45 mm syringe filter. The GPC calibration was done using a series of selected polystyrene standards that are of narrow molecular weights and cover the molecular weight range of the columns respective range of separation.

The cement compositions, dry rubber compositions, and finished rubber products are suitable for pharmaceutical applications, adhesives, sealants, automobile applications, and numerous other industrial applications. The cement compositions may be extruded, compression molded, blow molded, injection molded, and laminated into various shaped articles including fibers, films, laminates, layers, industrial parts such as automotive parts, appliance housings, consumer products, packaging, and the like.

### EXAMPLES

### Scavenging of Unreacted pMS Monomers

This example illustrates the ability of the process to scavenge unreacted pMS monomers in order to prepare a cement composition comprising isobutylene-paramethylstyrene copolymers and substantially free of unreacted paramethylstyrene monomer. Solutions comprising isobutylene-paramethylstyrene copolymers were treated with bromine in the absence of free radical initiators in order to scavenge the unreacted pMS monomers. The concentration of unreacted pMS monomers was measured before and after scavenging using gas chromatography. The specific procedure is described below.

Hexane solutions of isobutylene-paramethylstyrene copolymer (cement, about 15-20 wt % polymer in hexane) with varying levels of pMS in the polymer and various levels of free pMS were studied. The cement was reacted with predetermined amounts of bromine in the absence of Vazo™ (a free radical initiator) and in the absence of a light source. The mixture was agitated for 30 minutes in an absence of visible light. Specifically, neither daylight nor fluorescent light sources contacted the cement. Infrared light was used to illuminate the cement without initiating free radical reactions. The reaction mixture was then quenched and neutralized with sodium hydroxide (NaOH) dissolved in water. The quenched mixture was then washed with water several times until the pH was neutral. A second addition of aqueous NaOH, followed by water washes, was conducted on select experiments.

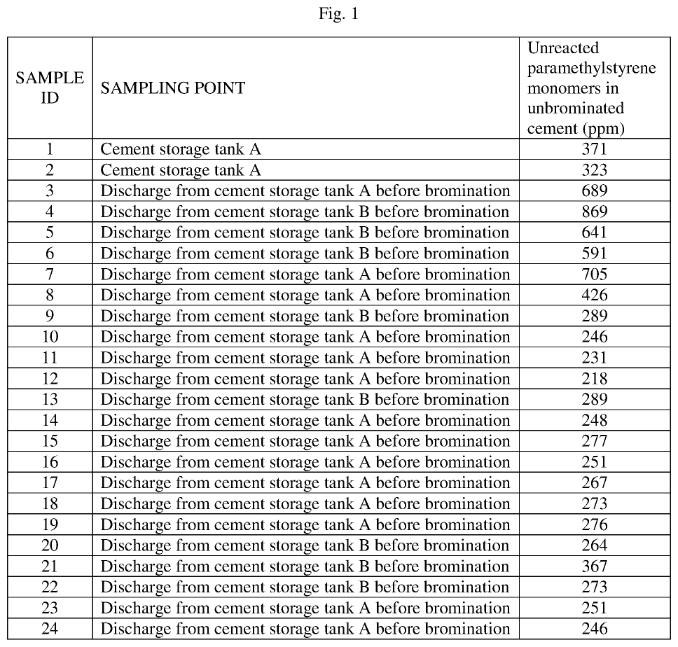

Gas chromatography was used in accordance with Test Method E242. A known amount of the cement (rubber in hexane) was treated with known excess amounts of acetone to precipitate the rubber. The supernatant liquid was used to determine the amount of free pMS. A known amount of the supernatant liquid was injected in to an Agilent™ 7890 with DB1 methylsilicone, 0.25 microliter (μm) film thickness, 0.25 mm I.D., 60 meters column and a FID detector. The amount of free pMS was calculated using an internal calibration of pMS in: 1) polymer solution before addition of bromine, and 2) polymer solution after washing with NaOH and water. FIG. 1 shows the level of free pMS observed in a typical Baytown plant isobutylene-paramethylstyrene cement product. If the free pMS in the cement shown in FIG. 1 is not scavenged, it will lead to pMS accumulation in the hexane recycle and subsequently lead to high stearic acid formation and high pMS in the dry rubber composition and finished rubber product.

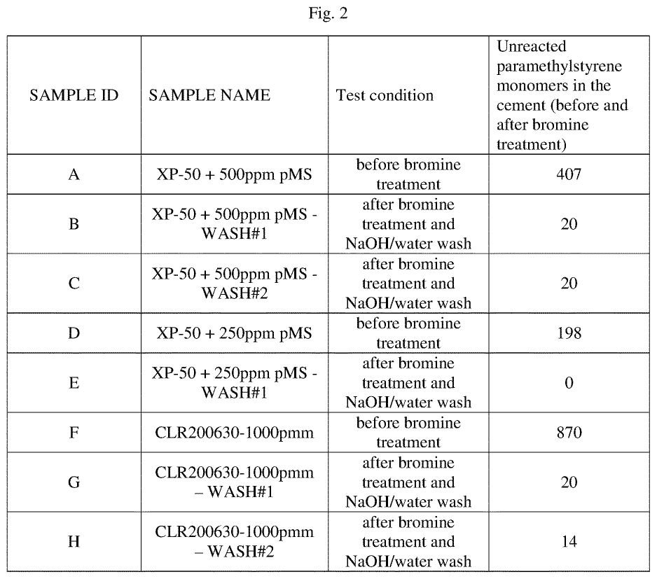

FIG. 2 shows the lab data before treating with bromine and after treating with bromine as a halogenic scavenger. From FIG. 2, it can be concluded that treating the cement with bromine in the absence of a free radical initiator, and subsequent neutralization and washing steps, can substantially reduce the amount of free pMS present in the cement. These steps can be applied in the current EXXPRO™ production to produce the isobutylene-paramethylstyrene copolymer (aka XP-50) product commercially.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

One or more specific embodiments of the process for producing copolymers of isobutylene and paramethylstyrene substantially free of paramethylstyrene monomers have been described. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

Certain terms are used throughout the description and claims to refer to particular features or components. As one skilled in the art will appreciate, different persons may refer to the same feature or component by different names. This document does not intend to distinguish between components or features that differ in name but not function.

Numbers disclosed herein are approximate values, regardless whether the word “about” or “approximate” is used in connection therewith. Whenever a numerical range with a lower limit and an upper limit is disclosed, any number falling within the range is specifically disclosed. Whenever the term “includes” is used it encompasses “includes, but is not limited to.” All documents described herein are incorporated by reference herein for purposes of all jurisdictions where such practice is allowed to the extent they are not inconsistent with this text.

Reference throughout this specification to “one embodiment,” “an embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment.

The embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to suggest that the scope of the disclosure, including the claims, is limited to that embodiment.

What is claimed is:

1. A method of preparing a cement composition comprising an isoolefin-alkylstyrene copolymer and being substantially free of an unreacted alkylstyrene monomer, the method comprising:
reacting an isoolefin monomer with at least a portion of an alkylstyrene monomer in a diluent to form an isoolefin-alkylstyrene copolymer;
replacing the diluent with a solvent;
reacting a halogenic scavenger with the unreacted alkylstyrene monomer in an absence of a free radical initiator to form a halogenic alkylstyrene compound without altering the isoolefin-alkylstyrene copolymer; and
removing the halogenic alkylstyrene compound from the solvent to form the cement composition substantially free of the unreacted alkylstyrene monomer.

2. The method of claim 1, wherein the halogenic scavenger comprises bromine.

3. The method of claim 1, wherein the alkylstyrene monomer comprises a paramethylstyrene monomer.

4. The method of claim 1, wherein the isoolefin monomer comprises isobutylene, isobutene, 2-methyl-1-butene, 3-methyl-1-butene, 2-methyl-2-butene, 1-butene, 2-butene, methyl vinyl ether, indene, vinyltrimethylsilane, hexene, 4-methyl-1-pentene, or combinations thereof.

5. The method of claim 1, wherein the halogenic scavenger comprises bromine, the alkylstyrene monomer comprises a paramethylstyrene monomer, and the halogenic alkylstyrene compound comprises dibromo paramethylstyrene.

6. The method of claim 1, wherein the diluent comprises ethyl chloride, methylene chloride, methyl chloride, CHCl₃, CCl₄, n-butyl chloride, chlorobenzene, or combinations thereof.

7. The method of claim 1, wherein the solvent comprises hexane.

8. The method of claim 1, wherein the cement composition comprises the alkylstyrene monomer at a concentration less than 20 ppm.

9. The method of claim 1, wherein reacting a halogenic scavenger with the unreacted alkylstyrene monomer in an absence of a free radical initiator comprises reacting the halogenic scavenger with the unreacted alkylstyrene monomer in an absence of visible light.

10. The method of claim 1, wherein the isoolefin monomer comprises a C₄-C₇ isoolefin.

11. The method of claim 1, wherein replacing the diluent with a solvent comprises pouring the solvent onto the diluent to vaporize the diluent and dissolve the isoolefin-alkylstyrene copolymer and the unreacted alkylstyrene monomer into the solvent.

12. The method of claim 1, further comprising finishing the cement composition to prepare a finished rubber product comprising less than about 0.1 wt. % stearic acid.

13. The method of claim 1, wherein removing the halogenic alkylstyrene compound from the slurry to form the cement composition substantially free of the unreacted alkylstyrene monomer comprises hydrolyzing and volatilizing the halogenic alkylstyrene compound.

14. The method of claim 1, further comprising halogenating the isoolefin-alkylstyrene copolymer in the presence of a free radical initiator to form a halogenated isoolefin-alkylstyrene copolymer.

15. The method of claim 1, further comprising stripping the solvent and extruding the cement composition to produce a dry rubber composition comprising less than 20 ppm unreacted alkylstyrene monomers.

16. A cement composition comprising:
an isoolefin-alkylstyrene copolymer; and
an alkylstyrene monomer comprising a concentration less than about 20 ppm.

17. The cement composition of claim 16, wherein the isoolefin-alkylstyrene copolymer comprises about 0.5 to about 20 mol % alkylstryene monomers and about 80 to about 99.5 mol % isoolefin monomers.

18. The cement composition of claim 16, wherein the isoolefin-alkylstyrene copolymer comprises a weight average molecular weight between 100,000 and 500,000 g/mol.

19. The cement composition of claim 16, wherein the isoolefin-alkylstyrene copolymer comprises a molecular weight distribution of 2.5.

20. A finished rubber product prepared from the cement composition of claim 16, wherein the finished rubber product comprises less than 0.1 wt. % stearic acid.
